(19) United States
(12) Patent Application Publication
(10) Pub. No.: US 2023/0339173 A1
(43) Pub. Date: Oct. 26, 2023

(54) ALIGNED MXENE FOR 3D MICROPATTERNING BY ADDITIVE MANUFACTURING

(71) Applicants: Sayli Jambhulkar, Gilbert, AZ (US); Siying Liu, Gilbert, AZ (US); Weiheng Xu, Chandler, AZ (US); Dharneedar Ravichandran, Tempe, AZ (US); Yuxiang Zhu, Gilbert, AZ (US); Kenan Song, Gilbert, AZ (US); Pruthvirajsinh Vala, Ridgecrest, CA (US)

(72) Inventors: Sayli Jambhulkar, Gilbert, AZ (US); Siying Liu, Gilbert, AZ (US); Weiheng Xu, Chandler, AZ (US); Dharneedar Ravichandran, Tempe, AZ (US); Yuxiang Zhu, Gilbert, AZ (US); Kenan Song, Gilbert, AZ (US); Pruthvirajsinh Vala, Ridgecrest, CA (US)

(21) Appl. No.: 18/307,278

(22) Filed: Apr. 26, 2023

Related U.S. Application Data
(60) Provisional application No. 63/334,936, filed on Apr. 26, 2022.

(51) Int. Cl. B29C 64/124; B33Y 70/10; B29C 64/245; B29C 64/321; B33Y 10/00; B33Y 80/00

(52) U.S. Cl. CPC B29C 64/124; B33Y 70/10; B29C 64/245; B29C 64/321; B33Y 10/00; B33Y 80/00; B29K 2671/02

(57) ABSTRACT

An additive manufacturing ink includes MXene nanoparticles including a titanium carbide represented by Ti₃C₂Tₓ, where x is an integer and each T is a functional group or an atom (e.g., O, F, OH, or Cl). Additive manufacturing includes depositing a first amount of an ink including MXene nanoparticles in a region of a microchannel defined by a substrate, allowing the first amount of the ink to flow in the microchannel by capillary action to form a first layer of the ink in the microchannel, depositing a second amount of the ink in the region of the microchannel, and allowing the second amount of the ink to flow in the microchannel by capillary action to form a second layer of the ink atop the first layer of ink. A pressure sensor includes a substrate defining a microchannel, and a multiplicity of MXene film layers deposited in the microchannel.

### CROSS-REFERENCE TO RELATED APPLICATION

This application claims the benefit of U.S. Patent Application No. 63/334,936 filed on Apr. 26, 2022, which is incorporated herein by reference in its entirety.

### TECHNICAL FIELD

This invention relates to additive manufacturing systems and methods using ink containing MXene nanoparticles, as well as devices fabricated with the ink.

### BACKGROUND

3D printing technology, as a layer-by-layer additive manufacturing, exhibits flexibility in terms of rapid prototyping, complex designing, material choices, and minimized waste for sustainability. 1D nanotubes and 0D nanospheres are nanomaterials used in conventional and 3D printing-based nanomanufacturing methods for morphology and hierarchy management. 2D nanomaterials with planar surfaces are thermodynamically nonstable and have a high propensity to form clusters composed of rippled sheets without long-range orders.

### SUMMARY

This disclosure describes systems and methods for fabricating high-resolution microchannels with parallelly deposited and anisotropically aligned MXene flakes on additively manufactured flexible substrates. As used herein, “MXene” generally refers to transition metal carbides, nitrides, or carbonitrides that exhibit high electrical conductivity. The micro-continuous liquid interface production (μCLIP) additive manufacturing (3D printing) technique is used to produce substrates with microscopic topographical features on which the MXene ink is directly and selectively deposited by the direct ink writing (DIW). In one implementation, the disclosed system and methods pattern the MXene-based compound titanium carbide represented by Ti₃C₂Tₓ, where x is an integer and each T is a functional group or an atom. In some cases, each T is O, F, OH, or Cl. The charge of the MXene typically depends on the surface termination groups and the value of x. The MXene can be negatively charged if it has surface termination groups that introduce negative charges, such as —O or —F. If the surface termination groups are balanced with positive and negative charges, or if they introduce no net charge, the MXene can be charge-neutral. The patterning method combines selective deposition and preferential alignment of the Ti₃C₂Tₓ particles in 3D patterned substrates. The printed devices formed from the disclosed method exhibited multifunctional conductivity and sensing properties, fast response times, and mechanical durability.

In a first general aspect, an additive manufacturing ink includes MXene nanoparticles including a titanium carbide represented by Ti₃C₂Tₓ, where x is an integer and each T is a functional group or an atom.

Implementations of the first general aspect can include one or more of the following features.

In some implementations, each T is O, F, OH, or Cl. In some cases, the MXene nanoparticles are flakes with a thickness less than about 10 nm and a mean lateral dimension between about 1 μm and about 10 μm. The first general aspect can further include an alcohol. In some implementations, a concentration of the MXene nanoparticles is in a range of about 1 mg/mL to about 100 mg/mL. In some cases, the MXene nanoparticles are dispersed in the alcohol.

In a second general aspect, a method of additive manufacturing includes depositing a first amount of an ink including MXene nanoparticles in a region of a microchannel defined by a substrate, allowing the first amount of the ink to flow in the microchannel by capillary action to form a first layer of the ink in the microchannel, depositing a second amount of the ink in the region of the microchannel, and allowing the second amount of the ink to flow in the microchannel by capillary action to form a second layer of the ink atop the first layer of ink.

Implementations of the second general aspect can include one or more of the following features.

In some cases, the microchannel has a width in a range of about 10 μm to about 200 μm, a depth in a range of about 10 μm to about 200 μm, a length in a range of about 1 mm to about 100 mm, or any combination thereof. The substrate can include a polymer. In some implementations, the polymer includes poly(ethylene glycol) diacrylate. In some cases, the first amount of ink and the second amount of ink are in a range of about 1 μL to about 10 μL.

In a third general aspect, a pressure sensor includes a substrate defining a microchannel and a multiplicity of MXene film layers deposited in the microchannel. Each MXene film layer includes MXene nanoparticles including a titanium carbide represented by Ti₃C₂Tₓ, where x is an integer and each T is a functional group or an atom.

Implementations of the third general aspect can include one or more of the following features.

In some implementations, each T is O, F, OH or Cl. In some cases, the multiplicity of MXene film layers includes 2 to 100 film layers. In some implementations, the multiplicity of MXene film layers varies in electrical resistance and conductivity with a change in pressure applied to the multiplicity of MXene film layers. The multiplicity of MXene film layers can vary in electrical resistance and conductivity with a change in shape of the multiplicity of MXene film layers. In some implementations, the multiplicity of MXene film layers has a width in a range of about 10 μm to about 200 μm, a depth in a range of about 10 μm to about 200 μm, a length in a range of about 1 mm to about 100 mm, or a combination thereof. In some cases, the substrate includes poly(ethylene glycol) diacrylate. The MXene nanoparticles can include flakes with a thickness of less than about 10 nm, a mean lateral dimension between about 1 μm and about 10 μm, or a combination thereof.

This technique enables anisotropic micropatterning and ordered assembly with face-to-face and edge-to-edge contact between 2D flakes on complex 3D printed substrates. The μCLIP-DIW hybrid 3D printing technology can be used for fast, scalable, large-volume, and low-cost patterning and assembly of general nanoparticles for broad applications with manufacturability and device functionality demonstrations.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1A depicts the additive manufacturing (3D printing) of substrate surface patterns by micro-continuous liquid interface production (μCLIP) technique. FIG. 1B depicts direct ink writing (DIW) using ink including MXene nanoparticles for directed MXene assembly with anisotropic deposition and preferential alignment. FIG. 1C is a schematic of the alignment mechanism with micro force balances between the shear from the ink flow (F_{c1}), gravity (F_{g}), drag force (F_{d}), capillarity (F_{c2}), and Van der Waals (F_{vdw}) between adjacent layers (Lₙ). FIG. 1D shows the surface topography of microfeatures including microchannels on the μCLIP printed substrate. FIG. 1E is a magnified view of FIG. 1D showing the ends of the microchannels.

FIG. 2A depicts a pressure sensor including MXene film layers deposited in microchannels that have been μCLIP printed on a substrate. FIG. 2B is a plot of resistance versus time applied by handwriting as measured by the pressure sensor illustrated in FIG. 2A.

FIG. 3A is a scanning electron microscopy (SEM) image of the stacked Mₙ₊₁AXₙ (MAX) phase of the parent Ti₃AlC₂. FIG. 3B is an SEM image of the delaminated MXene nanoparticles. FIG. 3C is an SEM image of a single flake MXene. FIG. 3D shows X-ray diffraction XRD plots of MAX and MXene. FIG. 3E is a plot showing MXene nanoparticle size distribution. The inset of FIG. 3E is a single MXene nanoparticle outlined by the dashed line.

FIGS. 4A and 4B are optical images of the patterned surfaces of linear microchannels before and after MXene ink droplet deposition, respectively. FIG. 4C is a magnified view of FIG. 4B showing homogeneous MXene distribution. FIGS. 4D-4G show optical images of μCLIP printed, complex surface patterning of microchannel patterns.

### DETAILED DESCRIPTION

This disclosure describes systems and methods for fabricating high-resolution microchannels with parallelly deposited and anisotropically aligned MXene flakes on additively manufactured flexible substrates. The micro-continuous liquid interface production (μCLIP) additive manufacturing (3D printing) technique is used to produce substrates with microscopic topographical features on which the MXene ink is directly and selectively deposited by direct ink writing (DIW). As used herein, “MXenes” generally refer to multi-layered 2D inorganic compounds (e.g., transition metal carbides, nitrides, or carbonitrides) that exhibit high electrical conductivity. MXenes exhibit customizable dimensions, tunable surface charges, and excellent dispersity suitable for assembling hierarchical architectures. Colloidal inks including MXenes nanoparticles exhibit hydrophilicity and dispersity that make them suitable for wet-processable assembling and patterning applications.

A multilayered MXene film is formed in a layer-by-layer fashion through flowing, confining, and stacking MXene ink into surface microchannels by capillary action. The MXene ink flows into microchannels in the substrate surface by capillary action, experiencing long-range and short-range forces that facilitate positional and orientational alignment of MXene flakes. In addition to a well-aligned assembly, the high-resolution and high-aspect-ratio patterning of MXene over a macroscale area allows for tuning functional properties of the composite structures. The disclosed technique enables anisotropic micropatterning and ordered assembly with face-to-face and edge-to-edge contact between 2D flakes on complex 3D printed substrates. The μCLIP-DIW hybrid 3D printing technology can be used for fast, scalable, large-volume, and low-cost patterning and assembly of general nanoparticles for broad applications with manufacturability and device functionality demonstrations.

The disclosed additive manufacturing systems and methods integrate the surface-designable μCLIP technique and nanoparticle-ordering DIW method and provided a layer-by-layer additive manufacturing for the directed assembly of 2D MXene flakes. The highly uniform MXene from the synthesis, the ink rheology control, and the 3D printed surface patterning are used in directed MXene assembly at low nanoparticle concentrations and minimal viscosity. The additively deposited droplet numbers and the suspension concentrations lead to MXene thin films with multilayered stacking, anisotropic alignment, and closely packed deposition morphologies. The laminates between the polymer substrates and layered MXene flakes form mechanically flexible devices susceptible to bending and pressure. The technology is used for demonstrations in human body motion and signature mode identifications. This approach of combining μCLIP printing of patterned substrates and DIW using inks including MXene nanoparticles can be used for nanomaterial assembly and broad applications, such as structural composites, sensors, actuators, human-machine interfaces, cryptosecurity, and soft robotics.

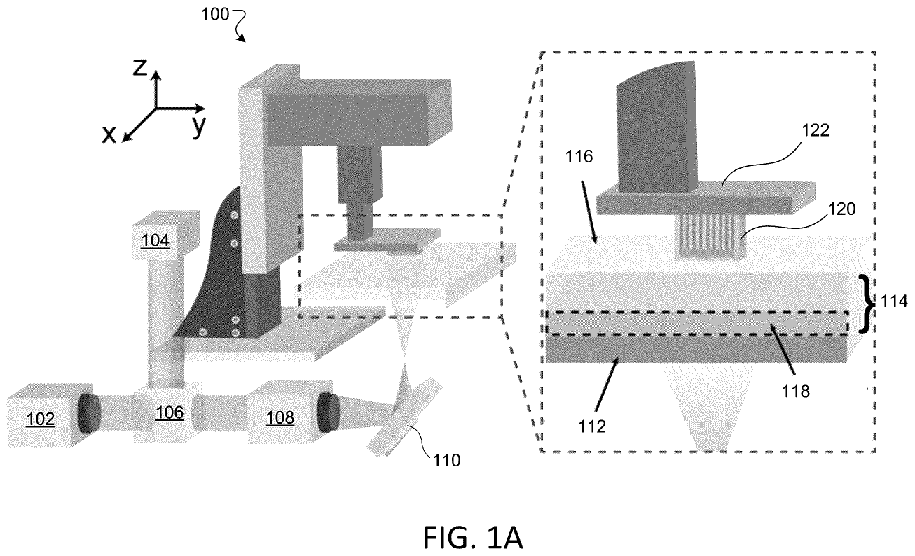

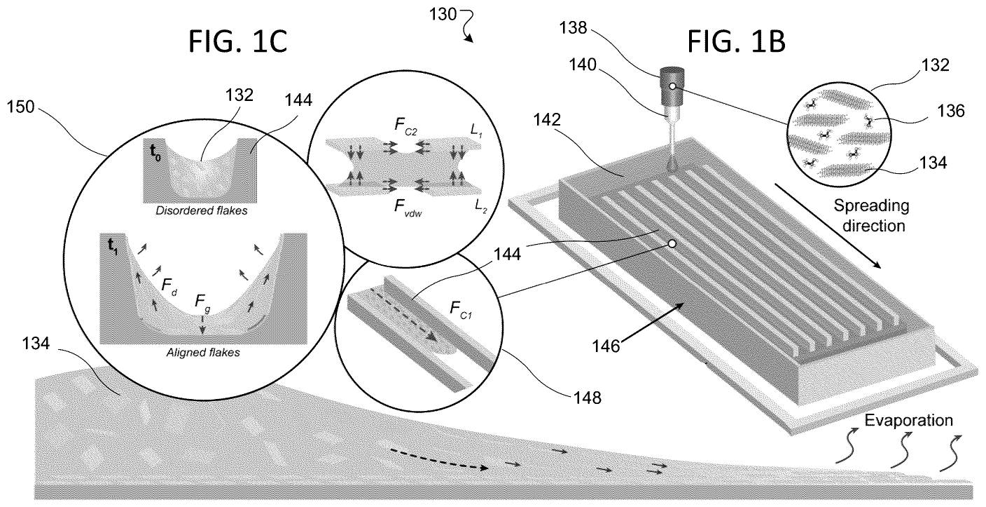

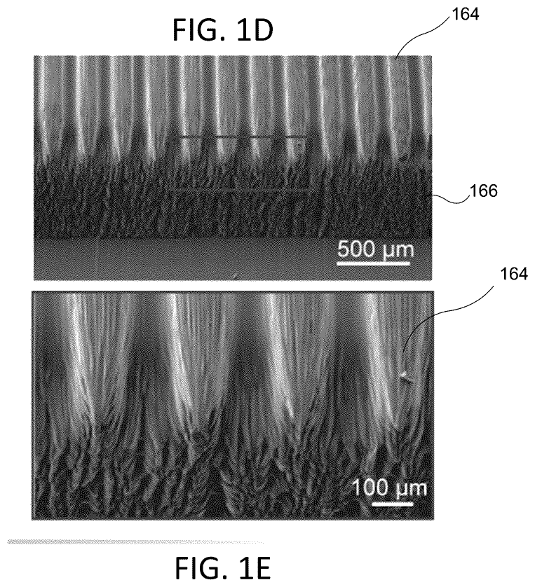

To achieve desirable MXene deposition sites, substrates with microchannel surface patterns are printed to regulate nanoparticle localization. The patterned substrates are printed by the micro-continuous liquid interface production (μCLIP) additive manufacturing (3D printing) technique illustrated by FIG. 1A. The projection system of the μCLIP printer 100 includes ultraviolet (UV) light engine 102, charge coupled device (CCD) camera 104, birefringence system 106, UV lens 108 and mirror 110. The projection system uses the CCD camera and a computer for real time monitoring and focal plane adjustment of the UV-light pattern projected onto the UV-transmissive and oxygen-permeable window 112 and into reservoir 114 including photosensitive resins. Between the photoactive region of the reservoir 116 and the window 112 is an oxygen-containing “dead-zone” 118 in which photopolymerization is inhibited. UV-induced polymerization of the photosensitive resin in the pattern projected by the printer occurs only in the relatively oxygen-free photoactive region 116. The printing dead-zone 118 prevents the attachment of the forming printed substrate 120 onto the window 112, thus allowing continuous fabrication of the substrate 120 as it is drawn up out of the photosensitive resin reservoir 114 by the sample elevator platform 122. In one example, the polymer poly(ethylene glycol) diacrylate (PEGDA) is used as a photosensitive hydrogel to form the substrate along with photo absorbers and photoinitiators, displaying hydrophilic surface tension required for MXene deposition. The μCLIP 3D printing method enables faster manufacturing and layer-less microstructures with lower surface roughness than general vat polymerization-based 3D printing.

FIGS. 1B and 1C illustrate the additive manufacturing method DIW procedure 130 for nanoscale deposition of 2D nanoparticles (e.g., MXene layers) and microscale stacking with closely packed orders. Automatic deposition of MXene ink suspensions by DIW procedure 130 is used due to its high manufacturing flexibility and high compatibility with the μCLIP printing method on the same 3D printing platform. Additive manufacturing ink 132 includes MXene nanoparticles 134 including a titanium carbide represented by Ti₃C₂Tₓ, where x is an integer and each T is a functional group or an atom. In some cases, each T is O, F, OH, or Cl. The charge of the MXene typically depends on the surface termination groups and the value of x. The MXene can be negatively charged if it has surface termination groups that introduce negative charges, such as —O or —F. If the surface termination groups are balanced with positive and negative charges, or if they introduce no net charge, the MXene can be charge-neutral. In some cases, Ti₃C₂Tₓ is dispersed in alcohol 136 (e.g., ethanol). The MXene nanoparticles 134 can be flakes with a thickness less than about 10 nm and a mean lateral dimension between about 1 μm and about 10 μm. The concentration of the MXene nanoparticles 134 in the ink 132 can be in a range of about 1 mg/mL to about 100 mg/mL. Additive manufacturing ink 132 including MXene nanoparticles 134 is contained in nozzle reservoir 138. A first amount of the ink including MXene particles is deposited through nozzle 140 in a region 142 proximate to one or more microchannels 144 defined by substrate 146. The first amount of the ink is allowed to flow in the microchannels 144 by capillary action 148 to form a first layer of ink in the microchannels 144. A second amount of ink is deposited in the region 142 proximate to the one or more microchannels 144. The second amount of ink is allowed to flow in the one or more microchannels 144 by capillary action 148 to form a second layer of ink atop the first layer of ink. The first amount of ink and the second amount of ink are in a range of about 1 μL to about 10 μL. The microchannels 144 can have a width in a range of about 10 μm to about 200 μm, a depth in a range of about 10 μm to about 200 μm, a length in a range of about 1 mm to about 100 mm, or any combination thereof.

After deposition of additive manufacturing ink 132 in region 142 through nozzle 140, the MXene assembly follows a two-step dynamic process. The initial step involves patterning driven by capillary action 148 along surface microchannels 144. The second process involves the evaporation thermodynamics-regulated nanoparticle assembly 150 for orientational nanoparticle hierarchies.

FIG. 1D is a scanning electron microscopy (SEM) micrograph showing the μCLIP 3D printed substrate 166 defining microchannels 164. FIG. 1E is a magnified view of FIG. 1D. In this example, the microchannels have fixed cross-section dimensions (a height and bottom gap of ˜100 μm, and a top gap ˜200 μm). The μCLIP 3D printing method enables faster manufacturing and layer-less microstructures with lower surface roughness than general vat polymerization-based 3D printing. The substrate surface of μCLIP shows smooth morphology beneficial for uniform deposition of MXene flakes into microchannels due to higher printing resolution. In this way, the subsequently dropped inks would not form turbulent flows that might disrupt ordered nanoparticle morphologies. The desirable nanoparticle orders will be preferentially positional with orientational alignment along specific printing paths and well-manipulated stacking density or packing factor.

A homogeneous and smooth deposition of MXene film onto patterned polymer substrates enables high-performance electromechanical properties with electrical functioning and stretchable flexibility. The electrical resistivity and conductivity change upon mechanical loading is advantageous for designing highly sensitive gauge sensors. The piezoresistive properties are reflected by the electrical resistance variations when subjected to different pressure.

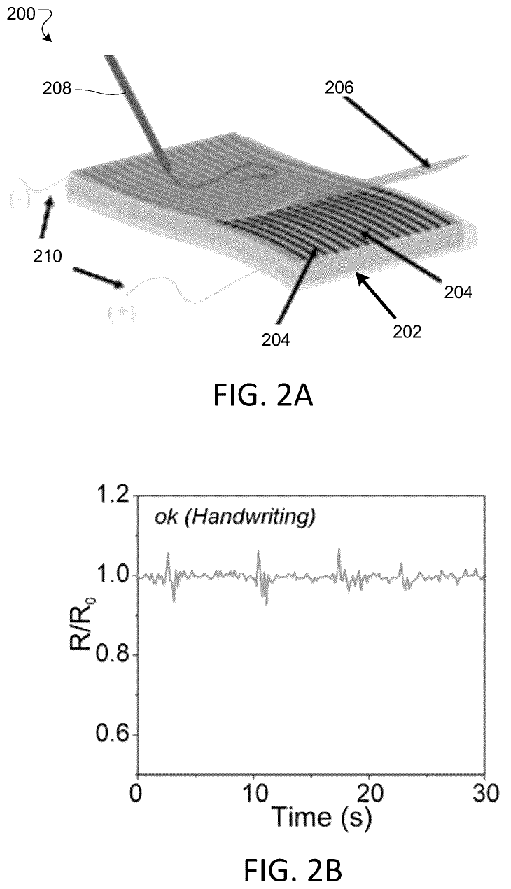

FIG. 2A depicts a pressure sensor 200 including a substrate 202 defining one or more microchannels 204, and a multiplicity of MXene film layers deposited in the one or more microchannels 204. Each MXene film layer includes MXene nanoparticles including a titanium carbide represented by Ti₃C₂Tₓ, where x is an integer and each T is a functional group or an atom. In some cases, each T is O, F, OH, or Cl. The multiplicity of MXene film layers varies in electrical resistance and conductivity with a change in pressure applied to the multiplicity of MXene film layers. The multiplicity of MXene film layers varies in electrical resistance and conductivity with a change in shape of the multiplicity of MXene film layers. In some examples, the multiplicity of film layers in the microchannels 204 includes 2 to 100 film layers. In certain examples, the multiplicity of MXene film layers has a width in a range of about 10 μm to about 200 μm, a depth in a range of about 10 μm to about 200 μm, a length in a range of about 1 mm to about 100 mm, or a combination thereof. The substrate 202 can be composed of a polymer such as poly(ethylene glycol) diacrylate. The MXene nanoparticles are typically flakes with a thickness of less than about 10 nm, a mean lateral dimension between about 1 μm and about 10 μm, or a combination thereof. The pressure sensor 200 can be covered with polydimethylsiloxane (PDMS) 206 to facilitate transfer of applied stress from the PDMS layer to the MXene film. In the example depicted in FIG. 2A, the applied stress is provided by a writing instrument 208 in contact with the PDMS layer 206 Electrical leads 210 can be used to assess the resistance changes of the MXene film layers as the pressure exerted by the writing instrument varies (e.g., during a handwriting signature event), as shown in FIG. 2B. These MXene-based sensors can be used for sensing a wide range of pressure values with applications in areas including cryptosecurity.

### Examples

### Theoretical Framework for the Capillary-Driven 2D Nanoparticle Assembly.

The capillary effect is a liquid's capability to flow in a narrow channel due to intermolecular forces and surface tension between the liquid and surrounding surfaces, propelling the flow against viscous and/or gravitational forces. The phenomenon of capillary action gives a great advantage over external fields (e.g., electrical, magnetic) in precisely controlling the diffusion and convection of various nanoparticles. Here, the MXene/ethanol suspension droplets immediately spread into the microchannels (e.g., a flow rate of 10 mm/s) within a channel at the size scale of ˜100-200 μm as illustrated in FIG. 1C. The surface tension for the PEGDA substrate and ethanol is 36.66 and 21.55 mJ/m², respectively, promoting a better spreading of MXene/ethanol than with the MXene/water suspension (γ_{water}=72.8 mJ/m²). According to Jurin's law given by Eq. 1 and an observation of a wetting angle, the capillary force (F_{c1}) was a few orders of magnitude higher than gravity as listed in Table 1, validating its dominant role in driving the liquid flow and MXene dispersions along surface-patterned microchannels.

p_{c}=2γ cos θ/r_{c} (1)

In Eq. 1, p_{c} is the capillary pressure, γ is the liquid-air surface tension, θ is the wetting angle of the liquid on the surface of the capillary, and r_{c} is the interface radius. Also, the Reynolds number for the suspension fluids given by Eq. 2 is as small as ˜0.078, representing a laminar flow within the channel. This laminar flow is critical in forming orientation-aligned particle morphologies, a phenomenon reported in different particle systems.

Re=ρvL/μ (2)

In Eq. 2, Re is the Reynolds number, ρ is the density of suspension fluids, v is the velocity of the fluid, L is the characteristic length, and μ is the fluid's viscosity. The low Re (Re<<1) of fluid implies a laminar Stoke's flow in microchannels enabling uniform dispersion of MXene. Followed this dispersion, the evaporation thermodynamics would lead to organized stacking and close packing of 2D layers.

TABLE 1
Approximate values of fluidic forces facilitating MXene assembly.

| | | Calculation | Value | |
|---|---|---|---|---|
| Force | | formulae | (N) | Comments |
| F_{c1} | Capillarity for | γ * 2cosθ * | 4.25 × | The dominant force that promotes the |
| | the ink liquid | b | 10⁻¹⁰ | motion of MXene/ethanol suspension from |
| | | | | the reservoir to the microchannel. |
| F_{d1} | Drag Force | ½ (C_{D} * ρ * | 2.06 × | Drag force transports the suspended MXene |
| | | A_{C} * v₁²) | 10⁻¹⁰ | particles into the microchannels. The |
| | | | | F_{d1} > F_{g}, thus particles will be uniformly |
| | | | | dispersed in the channels. |
| F_{d2} | Drag Force | ½ (C_{D} * ρ * | 2.3 × | The MXene particles confined inside |
| | | A_{C} * v₂²) | 10⁻¹⁹ | channels and aligned along with the |
| | | | | meniscus experience a gravitational force, |
| | | | | which leads to sedimentation of MXene |
| | | | | flakes. The drag force |
| | | | | (F_{d2}) opposing the sedimentation can be |
| | | | | ignored. |
| F_{g} | Gravity/ | V * Δρ * g | 1.25 × | It is a non-dominant force while the fluid is |
| | Sedimentation | | 10⁻¹⁵ | in motion in the channels (F_{g} < F_{c1}). |
| | Force | | | However, when the suspension inside the |
| | | | | microchannel stabilizes, the gravitational |
| | | | | force promotes the sedimentation of MXene |
| | | | | particles. This facilitates the layer-by-layer |
| | | | | deposition of particles at the bottom of |
| | | | | channels after ethanol evaporates. |
| F_{vdw} | Van der Waal's | — | 5 × 10⁻¹²- | After the evaporation of ethanol, particles |
| | Force | | 2.5 × 10⁻¹¹ | form closely packed morphology due to |
| | | | | Van der Waal's attraction force. |
| F_{c2} | Capillary force | — | 1- | The particles pinned at the meniscus would |
| | | | 25 × 10⁻⁸ | experience a Laplace pressure gradient and |
| | | | | pulled together when they come close in the |
| | | | | range of a few 10's or 100's of nm. |

Directed nanoparticle assembly by evaporation thermodynamics-based deposition on the patterned substrate is a complex phenomenon combining short-range and long-range driving forces as depicted in FIG. 1D. Table 1 lists the micromechanics analysis considering all micro forces, including gravity (F_{g}), drag force (F_{d}), Van der Waals force (F_{vdW}), and capillary forces (F_{c1} & F_{c2}). The F_{c1}, F_{g}, and F_{d} are universally long-range, disregarding the nanoparticle positions or relative spacing. The F_{vdW} and F_{c2} are a short-range attraction, with the typical working spacing of nanometers among MXene. The capillary force here for attracting the nanoparticles together (F_{c2}) is different from the capillarity driving the liquid into the microchannels (F_{c1}) mentioned before. The convective flow of the liquid by capillary action confines the droplet between the microchannels. The MXene suspension was pinned at the edge of the channels and formed a “U” shape substrate-solvent-air triple contact line that moves down the horizontal channel by externally applied convective force as depicted in FIG. 1D. The constant solvent evaporation from the substrate-solvent-air interface drives the MXene from the liquid body to the meniscus front by convection. Nanoparticles experience a drag force (F_{d}) consistent during the suspension transport from the droplet reservoir to the microchannel and the colloidal diffusion from the microchannel interior towards the meniscus during evaporation. The nanoparticles closest to the solvent-air interface orients with the primary axis parallel to the contact line experiencing downward gravitational force (F_{g}), leading to layer-by-layer sedimentation. Once long-range order forces bring nanoparticles to close proximity, F_{vdW} (e.g., a weak attraction force between particles) and F_{c2} (e.g., Laplace pressure difference generated due to curved meniscus between the adjacent particles) facilitate the in-plane and out-of-plane MXene assembly along the microchannel bottoms and walls, respectively. Micro forces and the local confinement by the micro-channeled substrate are responsible for mesoscale nanoparticle hierarchies. Control of nanoparticle size, concentration in liquids, and flow rheology is used to manipulate the stacking density and, as a result, the printed device properties.

### MXene Synthesis and Characteristics Properties.

Directed assembly of 2D nanomaterials can have low in-plane bending modulus that easily wrinkles or buckles. As compared to flexible graphene, MXene layers show a high intension of 2D planar structure and flexibility of dimensional control. The metallic conductivity of MXene is allows for printing conductive and sensing devices. The synthesized nanoparticle size and size distribution are factors in determining the packing factor within constrained geometry (e.g., 100 μm-sized flakes may form a house-of-cards structure in a similar-sized grating and contain large amounts of voids).

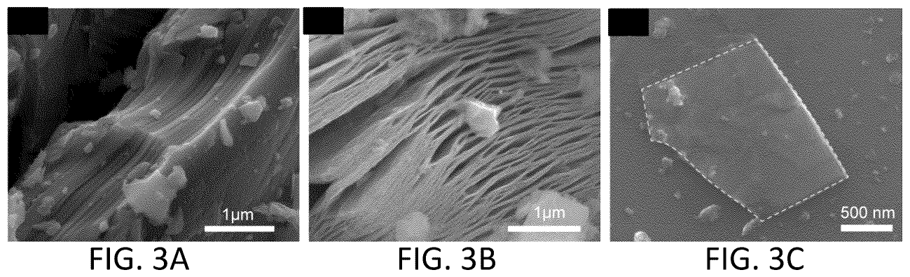

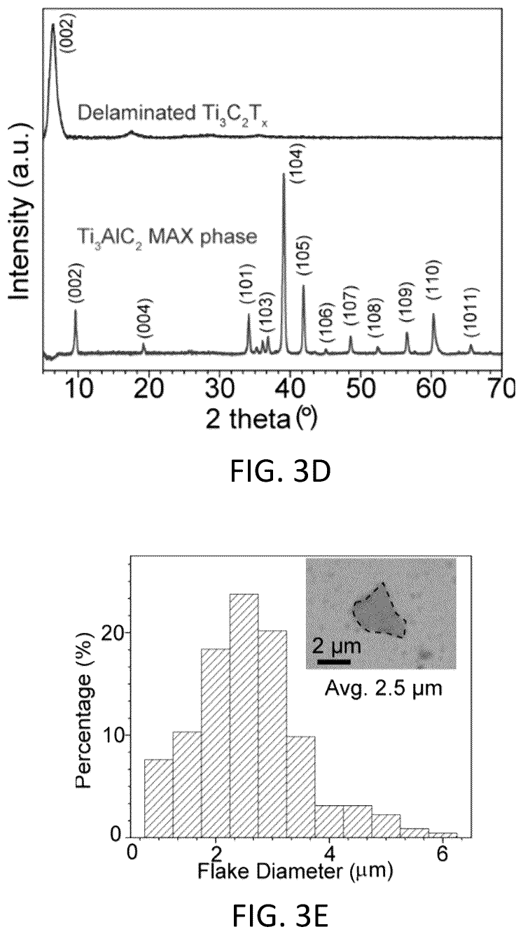

A Ti₃C₂Tₓ MXene dispersion was prepared using an in-situ hydrofluoric acid (HF) etching technique to customize nanoparticle size. The Ti₃AlC₂ powder prepared by a ball milling and heat treatment procedure was used as a Mₙ₊₁AXₙ (MAX) precursor as shown in FIG. 3A for the preparation of MXene flakes that can be seen as compact layers stacked by individual 2D MXene. The selective etching of Al layers from Ti₃AlC₂ showed a multilayered accordion-like structure as observed in the in FIG. 3B. The successful exfoliation of single/multilayered MXene flakes shown in FIG. 3C was formed through washing and sonication. After the etching of Al, the filtered MXene film contained a terminal surface of oxygen and fluorine, which was observed in energy dispersive spectroscopy (EDS) mapping. The cross-sectional view also showed individual Ti₃C₂Tₓ flakes and uniform distribution of Ti, Al, O, C, and F on the MXene flake surfaces. FIG. 3D shows X-ray diffraction (XRD) patterns of the parent Ti₃AlC₂ MAX phase and Ti₃C₂Tₓ nanosheets. The successful delamination of Ti₃C₂Tₓ MXene was reflected by the shift in typical (002) diffraction peak for 2θ from 9.58° to 6.45° due to increased interlayer spacing from Angstrom to nm, accompanied by the disappearance of (101), (104), (103), and (105) crystalline peaks. Atomic force microscopy (AFM) image show pristine MXene flake with a lateral dimension of around ≈2.5 μm. The MXene nanosheets in the aqueous suspension exhibited good stability due to the polar and hydrophilic functional groups (—O, —OH, —F) on its surface, which was demonstrated by the Tyndall effect. For the deposition of nanoflakes, Ti₃C₂Tₓ ink was made of predominantly single flakes with a thickness of nm, and the mean lateral dimension is ≈2.5 μm as shown in FIG. 3E.

Rheological Characterization of MXene Printing Inks. Achieving stable dispersion quality with nanoparticle homogeneity and controlled rheological properties influences in the uniform deposition of MXene films. MXene nanoparticles were suspended in ethanol to form varying suspension concentrations (e.g., 10, 20, and 50 mg/ml), out of which 10 and 20 mg/ml showed excellent stability, whereas 50 mg/ml showed sedimentation after ≈24 hr because the stronger nanoparticle interactions lead to the formation of agglomerates. At low concentrations, ethanol molecules were attached to MXene flakes by hydrogen bonding, but an increase in the number of MXene flakes resulted in the aggregation to form a 3D network by hydrogen bonding, which decreased the fluidity of the dispersion.

The measured viscosity as a function of shear rates (e.g., MXene/ethanol of 10, 20, and 50 mg/ml) showed that the viscosity increased as a function of MXene/ethanol concentration. The viscosity-shear rate plots showed a non-Newtonian and shear-thinning (pseudoplastic) behavior for MXene/ethanol suspensions of 20 and 50 mg/ml, ideal for most 3D printing techniques due to the facilitation of flow through thin-diameter printing nozzles. Extreme high and low viscosity values are disadvantageous due to the following reasons. (i) Highly viscous printing materials would clog the print head and cause manufacturing inconsistency, and (ii) low viscosity feedstock would behave as liquids and cannot retain their dimensional features upon exiting the printhead, leading to reduced printing resolutions or structural collapse. The surface patterning can be used to constrain the liquid transport across the channel-normal directions. Therefore, the 10 mg/ml MXene/ethanol showing Newtonian flow behavior would also work for the disclosed printing systems due to the MXene confinement within the 3D printed microchannels, providing more precise control of assembly thickness.

Rheological properties influence the final microstructure of the product by influencing individual sheet stacking. Thus, the magnitude of viscoelastic properties provides information on the processing, fabrication, and integration of MXene into complex architectures. The elastic (G′) and viscous (G″) moduli of the MXene dispersion have been determined as a function of frequency (rad/s) at fixed stress 0.015 Pa. For dilute concentrations 10 and 20 mg/ml, the dominance of viscous modulus (G″) over elastic component (G′) had a direct impact on ink processability. For example, the MXene dispersion was suitable for high rate processing methods where it was required to spread this colloid on the substrate surface on contact. This behavior plays a role in the elimination of the perturbation associated with conventional viscous fluids. The presence of G′ for such low concentrations enabled the processing of a very dilute Ti₃C₂Tₓ solution that facilitated fabricating a nanometer-thick MXene thin film. These rheological characteristics are suitable for processing extremely-low concentrations, leading to low mass selectively deposited at substrate surfaces with precise control over assembly thickness and morphology that has potential for many promising applications (e.g., layered hierarchies for structural ply, thermal exchange, microelectronics, optic reflectors, electromagnetic interference (EMI) shielding, and supercapacitors). The disclosed hybrid 3D printing uses low-concentration inks for their deposition selectivity, flowability, and nano manufacturability for well-manipulated MXene layers.

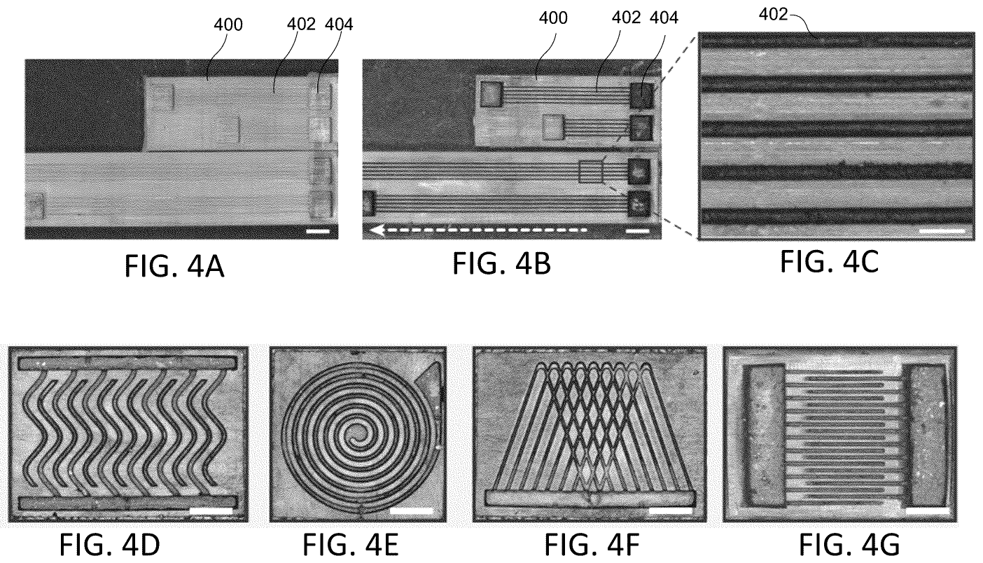

This hybrid 3D printing combines DIW with μCLIP to achieve multi-material and multiscale additive manufacturing. FIGS. 1A and 1B depict this μCLIP and DIW integration to deposit inks on patterned substrates with precise management of droplet sizes, sites, rates, and ink compositions. The μCLIP enabled the quick fabrication of substrate with micron-size features while DIW dispensed MXene inks on selective substrate sites, followed by the inks being transported into the microchannels by capillary action. The MXene ink (e.g., 10 mg/ml MXene nanoparticles in ethanol), with good flowability, was deposited on substrate 400 with printed surface patterns consisting of microchannels 402 of various lengths (e.g., 5, 10, 20, and 30 mm shown in FIG. 4A). As shown in FIG. 4B, the ink including MXene nanoparticles was deposited in region 404 and allowed to flow into the microchannels 402 by capillary action to form MXene layers in the microchannels 402. The flow rate for the samples shown in FIG. 4B was 10 mm/s. The disclosed technique enables high-throughput deposition of MXene film using limited material quantities, as only a droplet is required to fill up microchannels 402. FIG. 4C is a magnified view of FIG. 4B showing the uniform deposition of MXene within microchannels 402. FIGS. 4D-4G show region-specific deposition of multilayered MXene into intricate structures, including micro-supercapacitors, antennas, and other configurations that could not be achieved through dip-coating or vacuum-assisted filtration. The MXene assembly shows along-channel aligned morphology and stacked layers, separated by printed polymeric walls that prevent cross-contamination or short circuit of two electrodes during electrochemical applications. The multi-material deposition with alternate layers of two different nanoparticles (e.g., 2D with other 2D/1D/0D nanoparticles) was also demonstrated for multifunctionality purposes. This technique provides a versatile strategy for high resolution and large-scale production of anisotropic MXene thin films with complex geometries compared to conventional nanoparticle assembly methods.

Simulations using ANSYS Fluent Fluid Simulation Software were performed to theoretically verify the influences of capillary force, channel width, and concentration on nanoparticle distributions. The two-phase discrete model was used to describe the distribution of MXene particles into microchannels under capillary action. The analysis determined the particle concentration (mg/m³), velocity (m/s) and residence time (s) for varied MXene/ethanol concentrations (e.g., 10, 20 and 50 mg/ml) into 100×100 μm cross-section and 10 mm length microchannels. The pressure difference between the unfilled microchannel end and the filled droplet reservoir drives the MXene suspensions into the microchannels due to capillary force. As a result, the even distribution of particles into microchannels for the 10 mg/ml concentration was obtained within 1 s, which is consistent with the experimental observation. The increase in cross-section of the channels from 100×100 μm to 100×200 μm showed the reduction in capillary effect due to reduced interface radius and solvent/substrate wall adhesion, generating a reduction in solution transport velocity and particle redistribution rates. The increase in the concentration of solutions showed a rise in particle density and residence time while particle velocity was reduced as listed in Table 2. These simulations proved the capillarity effectiveness in driving inks and forming uniform particle distributions mandatory for desirable MXene morphologies and dimensions.

TABLE 2
Average values of particle properties velocity,
density, and residence time of MXene inks obtained
from ANSYS fluent simulation studies.

| Concentration | Density | Velocity (in channels) | Residence Time |
|---|---|---|---|
| (mg/ml) | (mg/mm³) | (mm/s) | (s) |
| 10 | 0.0129 | 16.1 | 0.090 |
| 20 | 0.031 | 14.5 | 0.121 |
| 50 | 0.053 | 14.3 | 0.163 |

### Structural and Morphological Characteristic of Printed MXene Multilayers.

After confirming the synthesized MXene quality and rheology appropriateness, the MXene suspensions were deposited with an individual droplet size of 3 μl onto the 3D printed substrate, leading to a layer-by-layer additive coating within the microchannels. The solution placed proximate the microchannel in inlets (e.g., reservoirs) was immediately transported into the microchannels from the droplet reservoir by capillary action. The subsequent evaporation of the solvent (e.g., ethanol) induced the aligned assembly of nanoparticles, leading to the coverage of a thin MXene layer on the microchannel's inner surfaces containing well-aligned flakes. The influences of (i) the number of ink droplets or additive layers <n> and (ii) ink concentrations on the microstructure and morphology of the multilayer coating were analyzed. For 10 mg/ml, the optical micrographs show that with an increasing number of layers (e.g., from 5 to 40), the coating width remained constant while the contrast was higher, indicating well-confined MXene assembly within microchannels and uniform deposition in additive manners. The 20 and 50 mg/ml concentrations were deposited into microchannels for different layer numbers as a comparison. With a droplet number of 40, the deposition of 10 mg/ml inks showed comparatively more uniform morphologies than 20 and 50 mg/ml inks, which was clear from the 3D surface mapping (e.g., smooth surfaces were observed along the microchannel for 10 mg/ml inks while irregular islands were observed for 20 and 50 mg/ml inks). For 10 mg/ml, the surface topography of MXene film deposited into microchannels showed continuous and uniform coating morphology. The higher interparticle interactions in concentrated dispersions (e.g., 20 and 50 mg/ml) contributed to nanoparticle agglomerations and unpredictable island formation inside the microchannels.

Cross-sectional SEM images of the substrate before and after the MXene printing showed a grooved microchannel structure (height and bottom gap of ˜100 μm and top spacing of ˜200 μm consistent with the surface patterning design). The SEM images indicated the two types of a thin coating of MXene nanoparticles on the substrates. 10 and 20 mg/ml showed a continuous and parallelly aligned film. This layered structure was attributed to the favorable deposition of MXene sheets by driving them into microchannels with the shear-assisted flow, aligning them along the flow followed by sedimentation, and interconnecting with each other to form a continuous and effective network, even at lower MXene concentrations and viscosity.

However, for concentrated suspensions (e.g., 50 mg/ml), the stacked MXene packing was absent, and the randomly packed MXene chunks were formed. The random orientation of MXene sheets in 50 mg/ml was possibly due to the viscoelastic properties in the colloidal suspensions behaving with more solid viscoelasticity where the particle interactions and inertia prohibit “long-range” rearrangement. Additionally, in a highly concentrated solution, nucleation occurs from the bulk of the solution when the deposited films were thick to facilitate the in-plane alignment by capillary and drag forces. The height profile analysis of the MXene multilayers showed the film thickness variation, suggesting the abrupt MXene accumulation from 10 & 20 mg/ml to 50 mg/ml due to trapped voids and lower packing factor. The XRD spectra of coating displayed a peak at ≈6° for 2θ, which was consistent with MXene nanosheet characteristics. The patterned structure also protected the stacked MXene from peeling off, as confirmed by the composite surface integrity after being scratched with objects of different surface roughness.

The obtaining of lower surface roughness and roughness variation affects many physical properties of the assembled MXene thin film, including thermal dissipation, electrical conductivity, and optical reflectivity. The root mean square (RMS) surface roughness measured by using a profilometer increased as a function of layer numbers and concentrations. For example, for 10 mg/ml, the surface roughness value of ≈2.2 and ≈4.7 μm was achieved for the <n> of 5 and 40, respectively. The multilayered film thickness increases with growing layer numbers and particle concentrations, with a higher consistency in lower MXene/ethanol concentrations. The MXene mass loading of the composites (e.g., polymer substrate/MXene surface coating) also increased linearly with <n> tested from the thermogravimetric analysis, which was consistent with the SEM observations. A variation of film surface roughness in highly concentrated inks (e.g., 50 mg/ml) was due to nanoparticle clustering and surface cracking that would disrupt the structural integrity and mechanical reliability. The residual stress generated in the film due to high surface roughness initiated microcrack formation and reduced area coverage on the microchannel surfaces (e.g., 50 mg/ml). The linear trend between the MXene thickness and the loading cycles showed the additive, layer-by-layer deposition characteristic as listed in Table 3. The coupling of the two 3D printing methods with capillary action allows for directed nanoparticle assembly without external active components (e.g., pressure, spinning force, electrical field, or magnetophoresis). A region-specific material deposition is feasible on more complex 3D patterns by tuning reservoir positions and size to transport desirable inks by microfluidic channels across substrate surfaces.

TABLE 3
MXene film thickness for different concentrations
and layer number <n>.

| Concentra- | | | | |
|---|---|---|---|---|
| tion | Layer thickness (μm) at deposition layer number <n> | | | |
| (mg/ml) | 5 | 10 | 20 | 40 |
| 10 | 0.50 ± 0.08 | 1.08 ± 0.41 | 3.97 ± 0.64 | 5.38 ± 1.46 |
| 20 | 0.65 ± 0.21 | 1.36 ± 0.47 | 4.92 ± 1.97 | 19.42 ± 2.48 |
| 50 | 0.89 ± 0.26 | 3.92 ± 1.10 | 13.84 ± 6.28 | 36.73 ± 6.28 |

### Electrical, Sensing, and Piezoresistive Properties.

For microelectronics, positioning and alignment of MXene flakes on complex substrates without any complex chemical and thermal treatment are of importance to the production of microelectronic devices. A homogeneous and smooth deposition of MXene film onto patterned polymer substrates enables high-performance electromechanical properties with electrical functioning and stretchable flexibility. The anisotropic electrical properties along patterned MXene direction were measured as a function of deposition numbers and ink concentrations. For 10 mg/ml inks, the sheet resistance was determined to be 30.33 kΩ/sqr for <n>=5, which decreased at a <n> number of 10, 20, and 40 (i.e., 25.76, 12.40, and 0.41 kΩ/sqr, respectively). This resistance reduction was due to the favorable MXene deposition, alignment, network continuity, and packing factor.

With the same printing layer of 40, an increase of MXene/ethanol ink concentration from 10 to 20 and 50 mg/ml increased the device resistance from 0.41 kΩ/sqr to 1.21 kΩ/sqr and 3.75 MΩ/sqr, respectively, showing a conductivity decrease of one to four orders of magnitude. The more concentrated solutions led to the formation of rough films in the microchannel, causing electron scattering and a decrease in surface electromigration efficiency (σ∝R⁻²). The electrical resistance of thin films is thickness-, surface roughness-, and area coverage-dependent. Based on the thickness and sheet resistance at <n>=40, the electrical conductivity of the films was calculated at 626.85 S/m, which was lower than pure Ti₃C₂Tₓ MXene film from vacuum filtration (e.g., ˜130 kS/m). This is possibly because of an insulating polymer matrix and the larger MXene layer spacing without vacuum effects. Even though the vacuum filtered films showed high electrical conductivity, these free-standing films were too brittle and fragile to resist crack propagations when subjected to subtle bending or fatigue. This conductivity management indicated that by adjusting the ink concentration, film thickness, and deposition morphology, the disclosed technique offers digital and additive manufacturing for micropatterning 2D MXene nanoparticles as a resistive/conductive network with a broad range of properties (e.g., an electrical resistance from a few hundred ohms to Mohm) and designable substrate flexibility.

The electromechanical performance of the multilayer film was characterized with the 3-point bending performed using Dynamic Mechanical Analyser (DMA) and the resistance change (R/R₀) measured continuously by a coupled multimeter. With the continuous increase of flexural strain to the sensor surface, the resistance (i) initially decreased because the MXene multilayers experienced compression on top of the printed device that decreased the inter-MXene spacing and increased the packing factor; and then (ii) increased due to initiation of failure of substrate generates cracks and disrupt the continuity of electron flow.

The electrical resistivity/conductivity change upon mechanical loading is advantageous for designing highly sensitive gauge sensors. For example, the resistance variation upon bending at different flexural strains of 1, 9, 18, 30, and 50% confirmed device sensitivity. The topmost surface experienced compression by bending the flexible substrate within elastic regimes (e.g., <<50%). Upon bending within this range, the MXene flakes came closer and overlapped with each other to form a tunnel junction, transporting electrons more easily through nanolayers by reducing their resistance. After the load removal, the sample bounced back to release its elastic energy due to polymer flexibility. During bouncing, the relocation of MXene, and surface defect generation increases the electrical resistance due to the extended interparticle spacing. However, the sample stretching beyond the elastic region induced a non-reversible resistance change due to the formation of defects (e.g., voids, delamination of nanoparticle layers). With an increase in applied flexural strain, the sample deformed more severely (e.g., more considerable surface compression during loading and more tension during unloading), explaining the increase in resistance change with stepwise loading and unloading cycles. The gaps and cracks formed due to stretching were not significant in destroying the conductive network; instead, they lengthened the electron conduction pathways.

To analyze the stability of the resistance response with mechanical cycling, the sensor was bent 100 times at 22% flexural strain without showing distinct signal decaying. High device sensitivity and mechanical reliability can detect delicate human motions, e.g., the index finger bending to different angles (e.g., 0 to 60°), bending along different longitudinal or transverse directions, and wrist rotation with the printed device attached along different directions. As the finger bending angle increased to 60°, the normalized resistance became ≈1.4 times more prominent, and the finger bending back to 0° recovered the initial resistance, implying a fast electron transport capability and stable structural integrity under bending and reloading cycles.

To further reveal the anisotropic piezoresistive property of the MXene sensor, the effect of bending direction and bending strain on the resistance response for a 2×2 cm device with 10 mg/ml <40> ink printing was analyzed. The angle between alignment/patterning direction and bending direction is defined as a bending angle ϕ. The resistivity changes were measured along the microchannel direction in response to the bending angle (i) 0° (longitudinal) and (ii) 90° (transverse). For a flexural strain less than 7%, the response changes along longitudinal and transverse directions were similarly negligible. However, with more considerable mechanical deformation (i.e., 10% to 25%), differences in response increased (e.g., 11% and 23% for ΔR/R₀(%) along with the transverse and longitudinal directions at a flexural strain of ˜23%), suggesting anisotropic electrical and sensing behaviors. The higher sensitivity along the longitudinal direction was due to the delicate displacement of MXene flakes and the generation of microcracks that impede electron transport. Along with the microchannel-normal directions, the alternating layers composed of conductive MXene and insulative polymers may serve as mechanical deformation barriers. The sensor's responsiveness was leveraged in the wrist movement sensing due to the unidirectional skin wrinkling.

The piezoresistive properties are reflected by the electrical resistance variations when subjected to different pressure. The sample was covered with polydimethylsiloxane (PDMS) in order to transfer applied stress from the PDMS layer to the MXene film. The change in resistive response (R/R₀) for the pressure ranging from ˜2 to 26 kPa demonstrates the incremental resistance change with increased pressure values. These values showed a stable response without signal attenuation under each loading and unloading cycle. The sensor showed high sensitivity (e.g., (ΔR/R₀)/ΔP) of 4.33 kPa⁻¹ under pressure less than 20 kPa and a relative lower sensitivity of 0.097 kPa⁻¹ above 20 kPa. The responses to lower surface pressure (e.g., <20 kPa) indicated greater sensitivity due to deformation in the MXene film that disturbed electron current pathways, broke the interlinks among MXene flakes, and increased film resistance. However, when the applied pressure increased beyond 20 kPa, the sensitivity decreased because the microstructure's deformation tends to saturate. The high sensitivity in this device was due to (i) aligned MXene and the directional electron transport with minimized scattering, and (ii) sensitivity transferred deformation from the flexible substrate to the embedded MXene film leading to microstructural defects and resistance increases.

The printed sensor showed a fast response time ≈0.3 s and a quick recovery time of ≈0.5 s ensuring timely feedback to external pressure. To evaluate the mechanical durability of an MXene-based sensor, constant pressure of 15 kPa was loaded and unloaded on the sample over 100 times, and no significant recession was observed, indicating high structural robustness. This demonstration proved high sensing reversibility due to the polymer substrate proception over the microchannel-contained MXene multilayers from delamination.

These MXene-based sensors possess high sensitivity, repeatable selectivity, and rapid response for sensing a wide range of pressure values that can enable cryptosecurity (e.g., fingerprint login, signature identification with highly precise anisotropic/isotropic, and continuous/discrete motion sensing). To test feasibility, the response of electron flow along the microchannels was recorded when an object moved on the device surface with a roughly constant pressure (e.g., a level of ˜10 N) along the MXene alignment direction (i.e., longitudinal) and microchannel-normal direction (i.e., transverse)). The sensor showed an increase in resistance to 45% and 14% when the object was moved in a longitudinal and transverse direction, respectively. Depending on an individual's unique writing characteristic (e.g., force, speed, and continuity), the sensor produced complex and unique waveforms detectable for signature recognitions and handwriting, such as “ok”, as shown in FIG. 2B, which can be used for anti-counterfeiting applications. Similarly, the sensor showed sensitive responses to finger pressure and lateral motion by dynamic finger tapping and releasing cycles, which is useful for tactile applications. These tests showed that the printed devices exhibited advanced sensing applications involving subtle variations in motion speed, direction, and force detectable with high accuracy and sensitivity.

MXene Synthesis. The MAX powders are made by mixing TiC (Alfa Aesar, 99.5%, 2 mm), Al (Alfa Aesar, 99.5%, −325 mesh), and Ti (Alfa Aesar, 99.5%, −325 mesh) powders in the molar ratio of 2:1.1:1. The mixed powder was heated under the flow of Ar filled alumina tube furnace at 1350° C. for 2 hr followed by furnace cooling at the rate of 5° C./min. The resulting loosely sintered powders were ground using gritstone. The milled powders were passed through a 400-mesh sieve to obtain fine powders of 38 μm particle size. 2 gm of LiF powder was dissolved in 20 ml 9M HCl solution. The solution was stirred for 10 min up to LiF salt completely dissolve in the acidic solution. Then, 2 gm of MAX was slowly added to the etchant mixture (i.e., HCl+LiF) to avoid a violent exothermic reaction. The mixture was stirred continuously at 500 rpm for 24 hr at 35° C. After etching was complete, the exfoliated mixture was repeatedly washed with DI water by centrifugation (3500 rpm 10 mins for each cycle) until the pH of the supernatant reached about 6. The sediment slurry was dispersed in deaerated water and delaminated by sonication under flowing Ar for 1 hr, followed by centrifugation at 3500 rpm for 1 hr. The stable MXene colloidal solution (supernatant) was collected and vacuum filtered through a PVDF membrane. The dried MXene flakes were dispersed in the solvent for further study.

3D Printing of Surface Patterns. The substrates with a micro grating of dimension 100 μm width, height, and spacing were manufactured through the micro-continuous liquid interface production (μCLIP) technique. The poly(ethylene glycol) diacrylate (PEGDA, average Mₙ 700, Sigma-Aldrich) resin was mixed with photoinitiator phenylbis(2,4,6-trimethylbenzoyl)phosphine oxide (Irgacure 819, 97%, Sigma-Aldrich, 2 wt %) and photo absorber 2-(2H-benzotriazol-2-yl)-6-dodecyl-4-methylphenol (Tinuvin 171, Sigma-Aldrich, 0.2 wt %). The μCLIP uses a Wintech Pro4500 light engine including a 385 nm light source as well as a Digital Mirror Device (DMD) consisting of 912×1140 pixels to generate the designed patterns. The CAD model was sliced into a sequence of 2D patterns with specific thicknesses along the Z-direction, which were then sequentially projected by the light engine. A UV lens (UV8040BK2, Universe Optics) was used to focus the projected patterns onto the printing platform with a CMOS (MU2003-BI, AmScope) used to monitor the focusing status of projected patterns. A Z-axis motorized stage (X-LSM200A-KX13A, Zaber) was used to generate the continuous movement of the printing stage with controlled speeds, an oxygen-permeable thin film (Teflon AF2400, 70 μm nominal thickness) was embedded in a customized resin bath, into which resin was dispensed and sequentially solidified upon the projected patterns. Printed samples were thoroughly cleaned with IPA and blow-dried with clean, dry air.

The Layer-by-Layer MXene Assembly by Direct Ink Writing of Low-Viscosity Colloids. The stable dispersion of MXene/ethanol having 10, 20, and 50 mg/ml concentrations was prepared by dispersing dried MXene powders into ethanol by sonication for 15 minutes. A solution of 3 μl of each concentration was deposited into the reservoir on the substrate patterns by a DIW syringe. The dispersion gets sucked into the microchannels by the capillary action followed by ethanol evaporation at RT (e.g., total time sec for the deposition and drying over a length of 10 mm microchannel). After evaporation, the monolayer of self-assembled MXene flakes is formed on the inner surface of microchannels. After drying of the previous MXene layer, an additive droplet is applied by the same process and the effect of several layer deposition <n> on the morphology and electrical properties was investigated. After the deposition, the substrates were kept in a vacuum desiccator until use.

Material Characterizations. The SEM images and EDS mapping were taken by vacuum field emission scanning electron microscope with XL30. AFM images were captured by Witech Alpha 300 RA. XRD spectra were obtained from a PAN analytical X'Pert PRO powder diffractometer in the range of 5-70° (2θ). The interlayer spacing of multilayered MXene was calculated according to the following Bragg's Law equation.

$$d = \frac{n λ}{2 d sin θ} \qquad ( 3 )$$

In Eq. 3, λ is the wavelength of the X-ray source is 1.54 Angstrom, and θ is the scattering angle of (002) peak. The thickness of the MXene film was obtained from the cross-sectional SEM images and measured by ImageJ software by averaging values at 10 different sites.

The optical image, 3D surface imaging, and film surface roughness of the substrate/MXene film were taken from the Keyence optical scanning microscope. The electrical and sensing properties of the MXene film were measured using the multimeter KEITHLEY through the 2-point probe technique. The metallic wires were attached at the end of 10 mm long samples by silver paste and encapsulated in PDMS to avoid environmental interference. The sensing response was measured as R/R₀, where R₀ is initial resistance and R is final resistance after the sample is subjected to strain or force.

The rheology test of MXene dispersion was conducted using TA instruments (Discovery HR2) rheometer with 40 mm 2° cone Peltier plate (amount ≈2 ml). The viscoelastic properties of the MXene dispersion were studied by measuring the viscosity, viscous, and elastic modulus of the sample as a function of frequency 0.1 to 100 Hz at a constant stress of 0.015 Pa at RT.

The TA Instrument's Dynamic Mechanical Analyser (DMA) (Discovery HR2) was used to perform three-point bending experiments on frame size 10 mm (sample size 1.3*5*10 mm). Samples were subjected to bending at a constant linear rate; stress vs. strain curve by DMA and resistance change by multimeter were measured. Pressure sensing was conducted on the KCube DC motor translation stage with an attached MLP-10 load cell. The customized 3D printed geometry was attached over the stage to apply load on the sample surface at a contact acceleration of 4.5 m/s². Thermogravimetric studies were performed by heating sample for RT −600° C. at 10° C./min heating rate at inert atmosphere using TA Instrument's TGA 550.

Calculations of Fluidic Forces:

The capillary force acting on fluid (F_{c1}):

$${F}_{c 1} = γ * ( \frac{cos {θ}_{r} + cos {θ}_{l}}{W} ) * b * w = γ * ( cos {θ}_{r} + cos {θ}_{1} ) * b = γ * 2 cos θ * b$$

Capillary Pressure: ΔP=γ*(cos θᵣ+cos θ₁)*b

$$Δ P = 22.39 \times {10}^{- 3} N / m * ( \frac{0.95 + 0.95}{1 {0}^{- 4} m} ) = 425.11 N / {m}^{2}$$

$${F}_{c 1} = Δ P \times {10}^{- 4} \times {10}^{- 4} = 4.25 \times {10}^{- 10} N$$

### Here,

θᵣ & θ₁=18°=Contact angles for ethanol on the right and left side of the channel
ΔP=Pressure difference between ends of microchannel
w=Width of channel (i.e., 100 μm)
b=Breadth of channel (i.e., 100 μm)
γ=Surface tension is taken between ethanol and air (i.e., 22.39 mN/m)
Drag Force (F_{d1} & F_{d2}):

F_{d}=½(C_{D}*ρ*A_{C}*v²)F_{d1}=½(C_{D}*A_{C}*v₁²)(Fluid flow into the channel)

F_{d1}=½(C_{D}*ρ*A_{C}*v₁²)

F_{d2}=½(C_{D}*ρ*A_{C}*v₂²)(Sedimentation)

F_{d1}=0.5×170×4000×2×10⁻⁶×2×10⁻⁶×0.012²=2.06×10⁻¹⁰ N

F_{d2}=0.5×255×4000×2×10⁻⁶×2×10⁻⁶×(3.33×10⁻⁶)²=2.3×10⁻¹⁹ N

### Here,

C_{D}=Coefficient of drag for flat disc (13.6/Re for parallel) and (20.4/Re for perpendicular) to flow
ρ=Density of particle=4000 kg/m³
A_{C}=Area of cross section for particle=2 μm×2 μm
v₁=Velocity of fluid=0.01 m/s (for particle transported into channel)
v₂=Velocity of particle during sedimentation=100 μm/30 sec=3.33×10⁻⁶ m/s

### Sedimentation Force (F_{g})

$${F}_{g} = V * Δρ * g = ( 1 \times {10}^{- 8} \times 2 \times {10}^{- 6} \times 2 \times {10}^{- 6} ) \times ( 4000 - 789.2 ) \times 9.81 = 1.25 \times {10}^{- 15} N$$

### Here,

V=Volume=2 μm×2 μm×10 nm
Δρ=ρ_{particle}−ρ_{fluid}=4000−789.2 kg/m³
g=Acceleration due to gravity=9.81 m/s²
Reynold's number for fluid:

$$Re = \frac{ρ {uD}_{H}}{μ} = \frac{( 789.2 \times 0.01 \times {10}^{- 5} )}{1 {0}^{- 3}} = 0.0789$$

### Here,

ρ=Density of ethanol=789.2 kg/m³
u=Fluid velocity in channels=0.01 m/s
D_{H}=Hydraulic diameter=100 μm
μ=Dynamic viscosity=10⁻³ Ns/m²
Reynolds number for particle:

$$Re = \frac{{DU}_{p}}{ν} = \frac{3.33 \times {10}^{- 6} \times 2 \times {10}^{- 6}}{1 {0}^{- 3}} = 6.66 \times {10}^{- 9} = \frac{3.33 \times {10}^{- 6} \times 2 \times {10}^{- 6}}{1 {0}^{- 3}} = 6.66 \times {10}^{- 9}$$

### Here,

Uₚ is characteristic particle velocity=3.33×10⁻⁶ m/s
D is the particle size=2 μm
ν is viscosity=10⁻³ Ns/m²

The particle and fluid Reynolds number are 0.0789 and 6.66×10⁻⁹ respectively (Re<<1), which represents a laminar Stoke's flow in the microchannels. Applying Stoke's flow conditions, it can be inferred that the inertial force acting on fluid is insignificant compared to the viscous force, enabling uniform dispersion of MXene particles. After the dispersion, the evaporation of ethanol initiates, and MXene particles experiences sedimentation force, while the drag forces acting on the particle surface are negligible. This ensures in-plane alignment of nanoparticles to achieve well-stacked film in the channels after evaporation.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. An additive manufacturing ink comprising:
MXene nanoparticles comprising a titanium carbide represented by Ti₃C₂Tₓ, where x is an integer and each T is a functional group or an atom.

2. The additive manufacturing ink of claim 1, wherein each T is O, F, OH, or Cl.

3. The additive manufacturing ink of claim 1, wherein the MXene nanoparticles are flakes with a thickness less than about 10 nm and a mean lateral dimension between about 1 μm and about 10 μm.

4. The additive manufacturing ink of claim 1, further comprising an alcohol.

5. The additive manufacturing ink of claim 1, wherein a concentration of the MXene nanoparticles is in a range of about 1 mg/mL to about 100 mg/mL.

6. The additive manufacturing ink of claim 4, wherein the MXene nanoparticles are dispersed in the alcohol.

7. A method of additive manufacturing, the method comprising:
depositing a first amount of an ink comprising MXene nanoparticles in a region of a microchannel defined by a substrate;
allowing the first amount of the ink to flow in the microchannel by capillary action to form a first layer of the ink in the microchannel;
depositing a second amount of the ink in the region of the microchannel; and
allowing the second amount of the ink to flow in the microchannel by capillary action to form a second layer of the ink atop the first layer of ink.

8. The method of additive manufacturing of claim 7, wherein the microchannel has a width in a range of about 10 μm to about 200 μm, a depth in a range of about 10 μm to about 200 μm, a length in a range of about 1 mm to about 100 mm, or any combination thereof.

9. The method of additive manufacturing of claim 7, wherein the substrate comprises a polymer.

10. The method of additive manufacturing of claim 9, wherein the polymer comprises poly(ethylene glycol) diacrylate.

11. The method of additive manufacturing of claim 7, wherein the first amount of ink and the second amount of ink are in a range of about 1 μL to about 10 μL.

12. A pressure sensor comprising:
a substrate defining a microchannel; and
a multiplicity of MXene film layers deposited in the microchannel, wherein each MXene film layer comprises MXene nanoparticles comprising a titanium carbide represented by Ti₃C₂Tₓ, where x is an integer and each T is a functional group or an atom.

13. The pressure sensor of claim 12, wherein each T is O, F, OH or Cl.

14. The pressure sensor of claim 12, wherein the multiplicity of MXene film layers comprises 2 to 100 film layers.

15. The pressure sensor of claim 12, wherein the multiplicity of MXene film layers varies in electrical resistance and conductivity with a change in pressure applied to the multiplicity of MXene film layers.

16. The pressure sensor of claim 12, wherein the multiplicity of MXene film layers varies in electrical resistance and conductivity with a change in shape of the multiplicity of MXene film layers.

17. The pressure sensor of claim 12, wherein the multiplicity of MXene film layers has a width in a range of about 10 μm to about 200 μm, a depth in a range of about 10 μm to about 200 μm, a length in a range of about 1 mm to about 100 mm, or a combination thereof.

18. The pressure sensor of claim 12, wherein the substrate comprises poly(ethylene glycol) diacrylate.

19. The pressure sensor of claim 12, wherein the MXene nanoparticles comprise flakes with a thickness of less than about 10 nm, a mean lateral dimension between about 1 μm and about 10 μm, or a combination thereof.
